(19) United States
(12) Patent Application Publication
(10) Pub. No.: US 2025/0086495 A1
(43) Pub. Date: Mar. 13, 2025

(54) MODEL GENERATION TECHNIQUES BASED ON AGGREGATION OF PARTIAL DATA

(71) Applicant: Adobe Inc., San Jose, CA (US)

(72) Inventors: Saayan Mitra, San Jose, CA (US); Xiang Chen, San Jose, CA (US); Sapthotharan Krishnan Nair, Santa Clara, CA (US); Renzhi Wu, Atlanta, GA (US); Anup Rao, San Jose, CA (US)

(21) Appl. No.: 18/367,393

(22) Filed: Sep. 12, 2023

(51) Int. Cl. G06N 20/00

(52) U.S. Cl. CPC G06N 20/00

(57) ABSTRACT

An edge node included in a decentralized edge computing network generates a federated partial-data aggregation machine learning model. The edge node learns one or more model parameters via machine learning techniques and receives one or more auxiliary model parameters from additional edge nodes in the decentralized edge computing network, such as from a neighbor node group. In some cases, a neighbor node is identified in response to determining that the neighbor node includes a model with a relatively high estimated relevance to the model of the edge node. The edge node modifies the model to include an aggregation of the learned model parameters and the received auxiliary parameters. Respective weights are learned for the learned model parameters and also for the received auxiliary parameters. During training to learn the respective weights, the edge node stabilizes the learned model parameters and the received auxiliary parameters.

### TECHNICAL FIELD

This disclosure relates generally to the field of machine learning model generation, and more specifically relates to techniques to aggregate machine learning models among multiple network sources.

### BACKGROUND

Contemporary modeling techniques for data often include federated learning techniques. For example, a computing system that is configured for modeling dynamic data, such as data that is persistently updated, can use federated learning techniques to update a model. However, contemporary federated learning techniques can be limited to offline learning, such as performing periodic updates using batches of received data. Federated learning techniques that are limited to offline learning are typically unable to respond to data that is received continuously, such as updating a model based on online training. In addition, contemporary federated learning techniques can generate a centralized model that is developed based on data received from multiple sources. However, such a centralized model can be subject to inefficient performance or a single point of failure, such as inefficiencies or failures related to delayed or severed communications between edge computing systems and a centralized computing system that provides the centralized model.

### SUMMARY

According to certain embodiments, an edge node included in a decentralized edge computing network generates a federated partial-data aggregation machine learning model. The edge node learns one or more model parameters via machine learning techniques and receives one or more auxiliary model parameters from additional edge nodes in the decentralized edge computing network. In some cases, the edge node receives the auxiliary parameters from a particular set of additional edge nodes, such as additional edge nodes identified in a neighbor node group. For example, the edge node identifies a particular additional edge node as a neighbor node in response to determining that the particular additional edge node includes a model with a relatively high estimated relevance to the model of the edge node.

The edge node modifies the model to include an aggregation of the learned model parameters and the received auxiliary model parameters. Additionally or alternatively, the model learns one or more respective weights for each set of model parameters, such as a first weight for the learned model parameters and a second weight for one or more auxiliary parameters received from a particular additional edge node. During training to learn the respective weights, the edge node stabilizes the learned model parameters and the received auxiliary parameters. In some cases, the edge node generates inference data by applying the model having the trained weights, such as to additional data received by the edge node.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of computing environment in which edge nodes are configured to generate machine learning models based on federated partial-data aggregation techniques, according to certain embodiments;

FIG. 2 is a diagram depicting an example of a decentralized edge computing network that includes edge nodes that are configured to generate respective federated partial-data aggregation machine learning models, according to certain embodiments;

FIG. 3 is a diagram of an example data flow for operations involved in federated partial-data aggregation machine learning techniques, according to certain embodiments;

FIG. 4 is a flow chart depicting an example of a process for training a machine learning model based on federated partial-data aggregation machine learning techniques, according to certain embodiments;

FIG. 5 is a flow chart depicting an example of a process for determining a neighbor node group for an edge node that is included in a decentralized edge computing network, according to certain embodiments; and

FIG. 6 is a block diagram depicting an example of a computing system for implementing an edge node in a decentralized edge computing network, according to certain embodiments.

### DETAILED DESCRIPTION

As discussed above, contemporary federated learning techniques include generating a centralized machine learning model. In some cases, the contemporary federated learning techniques create a single point of failure in a computing network that utilizes the centralized machine learning model. For example, a centralized model that is provided by a central computing system to edge computing systems can result in failure of the edge computing systems if communications with the central computing system are interrupted. Furthermore, a centralized machine learning model generated via contemporary federated learning techniques can cause inefficient modeling by one or more edge computing systems. For example, a central computing system could generate a centralized model based on a combination of data received from contemporary edge computing systems. However, the example centralized model could have poor accuracy for each of the contemporary edge computing systems. For instance, the centralized computing system could receive, from a first contemporary edge computing system, a first batch of data that has very low relevance for a second contemporary edge computing system, resulting in a centralized model that also has low relevance for the second contemporary edge computing system.

Certain embodiments described herein provide for applying federated partial-data aggregation techniques to generate machine learning models that are optimized for edge nodes in a decentralized edge computing network. In some cases, a particular edge node can identify a group of neighbor nodes in the decentralized edge computing network that have additional models with relatively high relevance to the particular edge node. The particular edge node receives partial model data from the neighbor nodes, such as partial model data that includes auxiliary model parameters and omits additional portions of the additional models. Based on an aggregation of the auxiliary parameters with local model parameters that are learned by the particular edge node, the edge node can generate a federated partial-data aggregation model that provides higher accuracy inference data, as compared to a contemporary machine learning model.

An edge node included in a decentralized edge computing network includes a local model, such as a machine learning model that generates inference data based on observation data received by the edge node. As an example, the local model could generate inference data about air quality for a geographic region associated with the edge node, based on observation data describing weather, vehicle traffic, or other activities that could impact air quality. The local model is a federated partial-data aggregation machine learning model that includes learned model parameters and auxiliary model parameters. The edge node generates the learned model parameters, such as by training the local model. The edge node receives the auxiliary model parameters from additional edge nodes in the decentralized edge computing network. In the example of an air quality model, the edge node could receive auxiliary parameters from additional edge nodes that are associated with other geographic regions, such as a first additional edge node for an additional geographic region that is upwind and a second additional edge node for an additional geographic region that is downwind.

In some cases, the example edge node limits the auxiliary parameters that are received, such as by identifying a group of neighbor edge nodes that have models with a relatively high relevance for the local model of the edge node. In the example air quality model, the edge node could identify the first additional edge node as a neighbor node based on a high relevance of auxiliary parameters from the first additional edge node, e.g., auxiliary parameters describing air quality upwind have a high relevance for the local model. In addition, the edge node could exclude the second additional edge node from the neighbor node group based on a low relevance of auxiliary parameters from the second additional edge node, e.g., auxiliary parameters describing air quality downwind have a low relevance for the local model.

Based on a combination of the learned model parameters and the received auxiliary parameters, the example edge node modifies the local model. In some cases, the edge node learns respective weights for the learned model parameters and the received auxiliary parameters. For example, the edge node determines a first weight for the learned model parameters and a second weight for the received auxiliary parameters. In some cases, the edge node stabilizes some or all of the parameters while learning the respective weights, such as freezing values of the learned model parameters and the received auxiliary parameters. The edge node modifies the local model to include the learned weights and applies the modified local model to additional received data. In the example air quality model, for instance, the edge node could apply the modified local model to generate inference data about predicted air quality for the geographic region, such as by applying the weighted learned and auxiliary parameters to additional observation data received by the edge node.

As used herein, the term “edge computing network” refers to a configuration for a computing network in which one or more included computing systems are configured to perform functions for respective portions of a computing environment that is external to the edge computing network. As used here, the terms “edge node” and “edge computing system” refer to computing systems that are configured to operate in an edge computing network. In an edge computing network, a particular edge node is capable of communicating with additional computing systems in a particular respective portion of the computing environment, such as additional computing systems that are not included in the edge computing network. In some cases, the particular edge node is associated with a particular respective portion of the computing environment based on a characteristic of the computing environment portion, such as a geographic characteristic, operational characteristic, or other suitable characteristics. As an example, an edge computing network could include a first edge node associated with a first computing environment portion located in Europe and a second edge node associated with a second computing environment portion located in Asia. As an additional example, an edge computing network could include a first edge node associated with a first computing environment portion for customer computing devices that subscribe to a first service and a second edge node associated with a second computing environment portion for customer computing devices that subscribe to a second service. As a further example, an edge computing network could include a first edge node associated with a first computing environment portion for customer computing devices for a first segment of users and a second edge node associated with a second computing environment portion for customer computing devices for a second segment of users.

As used herein, the term “decentralized” refers to a configuration for a computing network that includes multiple computing systems, in which none of the included computing systems is configured to perform operations that control operations of additional ones of the included computing systems. For example, in a decentralized edge computing network that includes multiple edge nodes, none of the included edge nodes is configured to perform functions that control operations of additional ones of the included edge nodes. In some cases, a decentralized computing network arranges included computing systems, such as edge nodes, in a network configuration that enables communication between any pair of included computing systems. Examples of network configurations that may be utilized by a decentralized computing network include peer-to-peer (P2P), star, mesh, ring, tree, hybrid, or other types of network configurations that enable communication between pairs of included computing systems.

As used herein, the term “local” refers to data that is received or generated by a particular computing system, such as an edge node in a decentralized edge computing network. For example, the edge node can be configured to receive local data, such as observation data, from one or more computing systems that are associated with the edge node. Additionally or alternatively, the edge node can be configured to generate a local model that includes parameters trained by the edge node. In some cases, the decentralized edge computing network is configured to prevent the edge node from accessing data that is non-local to the edge node. For example, the decentralized edge computing network can be configured to transmit, from the edge node, a request to an additional edge node, such as a request to receive copies of one or more auxiliary parameters. Additionally or alternatively, the decentralized edge computing network can be configured to provide, to the edge node, the requested copies while preventing the edge node from accessing the parameters that are generated by the additional edge node

As used herein, the term “online training” refers to a machine learning technique that includes continuous (or nearly continuous) training for a machine learning model. For example, a computing system configured for online training can receive data at multiple timesteps, such as batches of data that are received sequentially. Additionally or alternatively, the computing system configured for online training can update a machine learning model at some or all of the timesteps, such as training the model at each timestep based on data that was received at a previous timestep.

As used herein, the terms “neighbor node” and “neighbor edge node” refer to identification, by a particular edge node, of one or more additional edge nodes that have relevance to the particular edge node. Unless otherwise indicated, a particular node that is included in a particular decentralized edge computing network identifies neighbor edge nodes from additional edge nodes that are also included in the particular decentralized edge computing network. In some cases, the particular edge node identifies an additional edge node as a neighbor edge node responsive to determining that the additional edge node has a relatively high estimated relevance to the particular edge node. For example, the particular edge node determines that a model generated by the additional edge node includes one or more parameters that have a relatively high estimated relevance to a model generated by the particular edge node.

As used herein, the terms “model” and “machine learning model” refer to one or more computer-implemented data structures that are configured to provide inference data. In some cases, a computing system, such as an edge node, generates, trains, or otherwise modifies a model to provide inference data describing a predicted outcome of received data (e.g., observational data). Additionally or alternatively, a model generates output data, such as inference data, based on computer-implemented analysis of input data, such as received observational data.

Certain embodiments described herein provide improvements to computing systems configured to generate machine learning models. For example, an edge node can generate a federated partial-data aggregation machine learning model by applying particular rules for identifying neighbor nodes with auxiliary parameters that have a relatively high relevance. In some cases, the application of these rules by the edge node improves a technological result by optimizing the federated partial-data aggregation machine learning model for the edge node. Additionally or alternatively, the edge node can generate inference data with higher accuracy by applying the federated partial-data aggregation machine learning model to received data, as compared to applying a contemporary federated machine learning model. In some cases, the edge node can improve response time of the federated partial-data aggregation machine learning model by limiting model information that is received from additional edge node, such as reducing training time for the federated partial-data aggregation machine learning model. In some cases, a decentralized edge computing network that includes one or more edge nodes configured for generating respective federated partial-data aggregation machine learning models can improve network operations, such as by increasing network resiliency against communication failures or failures of individual edge nodes. For example, if some of the edge nodes in the example decentralized edge computing network lose connectivity, remaining edge nodes can continue to update and apply their respective federated partial-data aggregation machine learning models. The increased network resiliency of the example decentralized edge computing network configured with federated partial-data aggregation machine learning techniques can provide a technical improvement as compared to a centralized computing network configured with contemporary federated machine learning techniques.

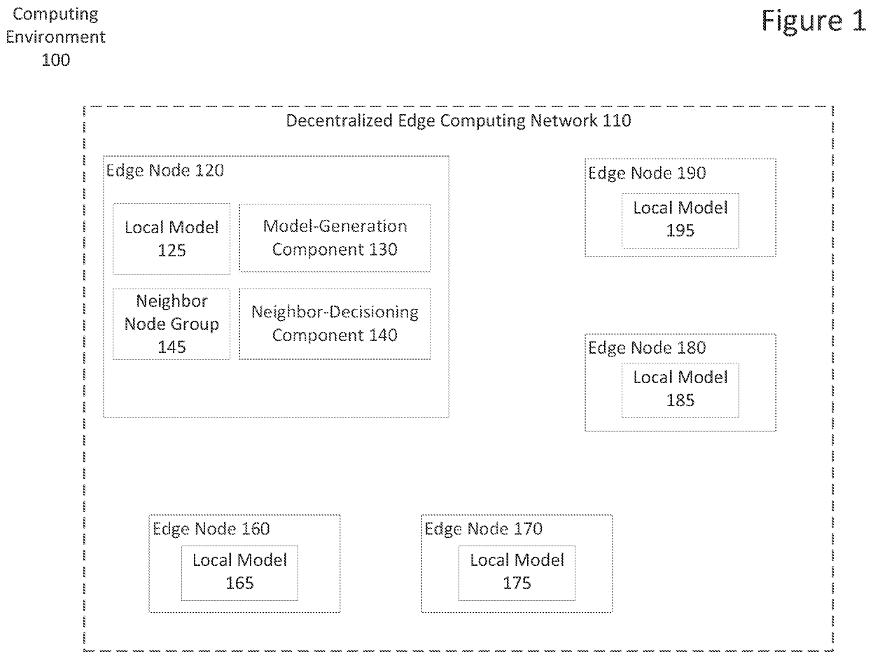

Referring now to the drawings, FIG. 1 depicts an example of a computing environment 100 in which one or more edge nodes are configured to generate, train, or otherwise modify respective machine learning models based on federated partial-data aggregation techniques. The computing environment 100 includes a decentralized edge computing network 110. Additionally or alternatively, the decentralized edge computing network 110 includes multiple edge nodes, such as an edge node 120, an edge node 160, an edge node 170, an edge node 180, and an edge node 190.

In FIG. 1, the decentralized edge computing network 110 is configured as an edge computing network in which each of the edge nodes 120, 160, 170, 180, and 190 performs one or more computing functions associated with a respective portion of the computing environment 100. For example, the edge node 120 receives data from a group of one or more additional computing devices that are included in the computing environment 100. In addition, each of the edge nodes 160, 170, 180, and 190 respectively receives additional data from a respective additional group of one or more additional computing devices that are included in the computing environment 100. In some embodiments, each of the edge nodes 120, 160, 170, 180, and 190 performs computing functions associated with a respective portion of the computing environment 100 that is located in a particular geographical region. For example, the edge node 120 could be associated with a portion of the computing environment 100 that is located in Europe, and the edge node 190 could be associated with an additional portion of the computing environment 100 that is located in central Asia. Additionally or alternatively, each of the edge nodes 120, 160, 170, 180, and 190 performs computing functions associated with a respective portion of the computing environment 100 that is associated with an operational activity. As an additional example, the edge node 120 could be associated with a portion of the computing environment 100 that includes computing devices for a first group of customers, e.g., basic cable subscribers, and the edge node 190 could be associated with an additional portion of the computing environment 100 that includes computing devices for a second group of customers, e.g., premium cable subscribers. Additional example associations between edge nodes in the decentralized edge computing network 110 and respective portions of the computing environment 100 may be envisioned.

In FIG. 1, the decentralized edge computing network 110 is configured as a decentralized computing network in which none of the edge nodes 120, 160, 170, 180, or 190 performs functions related to a centralized computing system. For example, none of the edge nodes 120, 160, 170, 180, or 190 is configured to perform functions that control operations of additional ones of the edge nodes 120, 160, 170, 180, or 190. In FIG. 1, the decentralized edge computing network 110 is described as not including a centralized computing system, but other implementations are possible. For example, a decentralized edge computing network that includes edge nodes configured to generate federated partial-data aggregation machine learning models could also include a computing system that is configured to perform some central functions that do not control operations of the edge nodes, such as central functions for backing up data or performing network maintenance.

In some embodiments, the decentralized edge computing network 110 can arrange the edge nodes 120, 160, 170, 180, and 190 in a network configuration that enables communication between any pair of edge nodes in the decentralized edge computing network 110, such as a peer-to-peer (P2P) network configuration, a mesh network configuration, or another suitable type of network configuration. For example, the edge node 120 could be configured to communicate with one, some, or all of the edge node 160, the edge node 170, the edge node 180, or the edge node 190. In addition, each of the edge nodes 160, 170, 180, and 190 can be configured to communicate with one, some, or all of the edge nodes 120, 160, 170, 180, or 190. For convenience and not by way of limitation, the example decentralized edge computing networks described herein do not describe an edge node as communicating with itself, e.g., the edge node 120 need not utilize the network configuration of the decentralized edge computing network 110 to communicate with itself.

In the computing environment 100, each of the edge nodes 120, 160, 170, 180, and 190 generates a respective machine learning model that is generated based on federated partial-data aggregation techniques. In addition, each respective federated partial-data aggregation model is generated and trained by the particular edge node in which it is included. For example, the edge node 120 includes a local model 125 that is a federated partial-data aggregation model generated and trained by the edge node 120. In addition, the edge node 160 includes a local model 165, the edge node 170 includes a local model 175, the edge node 180 includes a local model 185, and the edge node 190 includes a local model 195. Each of the local models 165, 175, 185, and 195 is a federated partial-data aggregation model generated and trained by, respectively, the edge node 160, 170, 180, and 190.

In the decentralized edge computing network 110, the edge node 120 includes one or more of a model-generation component 130 or a neighbor-decisioning component 140. In some embodiments, the model-generation component 130 performs one or more computer-implemented functions related to generating, training, or otherwise modifying the local model 125. Additionally or alternatively, the model-generation component 130 generates and trains the local model 125 based on federated partial-data aggregation machine learning techniques. For example, the model-generation component 130 generates or trains the local model 125 based on a combination of local data and auxiliary model parameters that are received by the edge node 120. In FIG. 1, the local data is received by the edge node 120 from the group of computing devices that are included in the respective portion (e.g., associated with the edge node 120) of the computing environment 100. Additionally or alternatively, the auxiliary model parameters are received by the edge node 120 from one or more of the edge nodes 160, 170, 180, or 190. In some cases, the edge node 120 is prevented from accessing additional local data that is associated with one or more of the edge nodes 160, 170, 180, or 190, such as additional local data received from additional computing devices included in additional portions of the computing environment 100 that are not associated with the edge node 120. For example, a privacy restriction may be implemented in the decentralized edge computing network 110, such as a privacy restriction that prevents any of the edge nodes 120, 160, 170, 180, or 190 from accessing local data that is associated with another one of the edge nodes 120, 160, 170, 180, or 190. Additional examples of restrictions that could prevent access, by a particular edge node, to local data that is associated with an additional edge node include security restrictions (e.g., encryption of data, potential data corruption with malicious code), geographic restrictions (e.g., physical distance between edge nodes, political jurisdictions), network configuration restrictions (e.g., bandwidth limitations), or other types of restrictions that can be implemented in a decentralized edge computing network.

In some embodiments, the neighbor-decisioning component 140 performs one or more computer-implemented functions related to determining a group of one or more neighbor edge nodes for the edge node 120, such as a neighbor node group 145. The neighbor-decisioning component 140 can generate or modify the neighbor node group 145 to describe one or more edge nodes included in the decentralized edge computing network 110. Additionally or alternatively, the neighbor-decisioning component 140 can generate or modify the neighbor node group 145 based on a determined relevance of a particular edge node to the local model 125. For example, the neighbor-decisioning component 140 can receive, such as from the model-generation component 130, one or more weights associated with each of the edge nodes 160, 170, 180, and 190. A first weight (or first group of weights) associated with the edge node 160 indicates an estimated relevance, with respect to the local model 125, of one or more parameters from the local model 165. In response to determining that the first weight exceeds (or otherwise fulfills) a neighbor selection threshold, the neighbor-decisioning component 140 can modify the neighbor node group 145 to include data identifying the edge node 160 as a neighbor node for the edge node 120. In addition, a second weight (or second group of weights) associated with the edge node 170 indicates an estimated relevance, with respect to the local model 125, of one or more parameters from the local model 175. In response to determining that the second weight fails to exceed (or otherwise fulfill) the neighbor selection threshold, the neighbor-decisioning component 140 can modify the neighbor node group 145 to include data identifying that the edge node 170 is a non-neighbor node for the edge node 120. In FIG. 1, the neighbor-decisioning component 140 identifies the edge nodes 160, 170, 180, or 190 as neighbor nodes or non-neighbor nodes in response to receiving respective weights that indicate an estimated relevance, to the local model 125, of parameters from the local models 165, 175, 185, or 195. In FIG. 1, identification of one or more of the edge nodes 160, 170, 180, or 190 as neighbor nodes or non-neighbor nodes for the edge node 120 does not necessarily indicate proximity (e.g., physical proximity, network proximity) or lack of proximity of the edge nodes 160, 170, 180, or 190 with the edge node 120.

In the decentralized edge computing network 110, the model-generation component 130 generates and trains the local model 125 based on federated partial-data aggregation techniques. The federated partial-data aggregation techniques can include determining, by the model-generation component 130 (or one or more additional components of the edge node 120) a combination of the local data received by the edge node 120 and the auxiliary model parameters that are received by the edge node 120 from one or more edge nodes that are identified, by the neighbor node group 145, as neighbor nodes for the edge node 120. For example, in response to receiving the local data, the model-generation component 130 performs one or more operations for modifying (e.g., updating) the local model 125 to include modified data observations, such as data observations that are received from the group of computing devices in the respective portion (e.g., associated with the edge node 120) of the computing environment 100. Additionally or alternatively, in response to receiving the auxiliary model parameters, the model-generation component 130 performs one or more operations for aggregating the auxiliary model parameters with one or more local model parameters in the local model 125. In some cases, the model-generation component 130 generates or modifies one or more weights associated with the auxiliary model parameters, such as weights indicating an estimated relevance of the auxiliary model parameters to the local model 125, as generally described above in regard to the neighbor-decisioning component 140. Additionally or alternatively, the model-generation component 130 provides the generated or modified weights to the neighbor-decisioning component 140. In response to receiving the generated or modified weights, the neighbor-decisioning component 140 can modify the neighbor node group 145, such as to identify a particular edge node from the decentralized edge computing network 110 as being included in or excluded from the neighbor node group 145. In some cases, the model-generation component 130 determines a weight for local parameters trained by model-generation component 130 in the model 125. Additionally or alternatively, the model-generation component 130 determines an additional weight for each set of auxiliary parameters received from a neighbor node.

In some embodiments, the edge node 120 iteratively modifies one or more of the local model 125 or the neighbor node group 145 based on federated partial-data aggregation techniques. For example, the model-generation component 130 iteratively modifies the local model 125 based on one or more modifications of the neighbor node group 145, such as by iteratively aggregating local model parameters in the local model 125 with auxiliary model parameters received from neighbor nodes identified in a most recent modification of the neighbor node group 145. Additionally or alternatively, the neighbor-decisioning component 140 iteratively modifies the neighbor node group 145 based on one or more modifications of the local model 125, such as by iteratively determining whether a weight included in a most recent modification of the local model 125 (e.g., a weight associated with a particular one of the edge nodes 160, 170, 180, or 190) fulfills the neighbor selection threshold.

In FIG. 1, each of the additional edge nodes 160, 170, 180, and 190 is configured to generate or train the respective local models 165, 175, 185, and 195 based on the federated partial-data aggregation techniques described in regard to the edge node 120. For example, each of the edge nodes 160, 170, 180, and 190 respectively includes a model-generation component that is configured to generate, train, or otherwise modify the respective one of the local models 165, 175, 185, and 195. Additionally or alternatively, each of the edge nodes 160, 170, 180, and 190 respectively includes a neighbor-decisioning component that is configured to determine a respective group of neighbor edge nodes. In some embodiments, identification of an edge node need not be reciprocal among multiple edge nodes. For example, if the neighbor node group 145 identifies edge nodes 160 and 190 as neighbor nodes for the edge node 120, the edge nodes 160 and 190 may, but need not, identify the edge node 120 as a neighbor node. In addition, if the neighbor node group 145 identifies edge nodes 170 and 180 as non-neighbor nodes for the edge node 120, the edge nodes 170 and 180 may, but need not, identify the edge node 120 as a non-neighbor node. As an example scenario of determining non-reciprocal neighbor nodes, the local models 125, 165, 175, 185, and 195 could model air quality for respective geographical areas associated with the edge nodes 120, 160, 170, 180, and 190. Continuing with this example, the edge node 120 could be associated with a first area that is typically downwind of a second area associated with the edge node 190. In this example, the neighbor-decisioning component 140 can identify the edge node 190 as being a neighbor node for the edge node 120 based on a determination that a weight associated with the edge node 190 indicates a relatively high estimated relevance, for the local model 125, of parameters from the local model 195, e.g., air particulate in the second area associated with the edge node 190 tends to be blown downwind towards the first area associated with the edge node 120. In this example, an neighbor-decisioning component of the edge node 190 can identify the edge node 120 as being a non-neighbor node for the edge node 190 based on an additional determination that an additional weight associated with the edge node 120 indicates a relatively low estimated relevance, for the local model 195, of parameters from the local model 125, e.g., air particulate in the first area associated with the edge node 120 does not typically blow upwind towards the second area associated with the edge node 190.

In some cases, implementation of the federated partial-data aggregation techniques improves operation of the edge node 120, or the additional edge nodes in the decentralized edge computing network 110. For example, aggregating partial data received from one or more additional edge nodes, e.g., model parameters that exclude additional local data, increases accuracy of the local model 125 while reducing or avoiding exposure of the edge node 120 to data that is restricted by the decentralized edge computing network 110. Additionally or alternatively, iterative modification of one or more of the local model 125 or the neighbor node group 145 based on the aggregated partial data improves accuracy of the edge node 120 by incorporating, in the local model 125, information about model parameters from additional edge nodes that have a relatively high relevance to the edge node 120. Furthermore, revising a federated model based on the aggregated partial data improves efficiency of the edge node 120, such as by reducing update time for model modifications by the edge node 120 and eliminating lag time associated with waiting for updates received from a centralized computing system.

In various embodiments, components of the decentralized edge computing network 110, such as the edge node 120, the model-generation component 130, the neighbor-decisioning component 140, or other components, can be implemented as one or more of program code, program code executed by processing hardware (e.g., a processor, a programmable logic array, a field-programmable gate array, etc.), firmware, or some combination thereof.

In some embodiments, one or more edge nodes included in a decentralized edge computing network are configured to perform federated partial-data aggregation data modeling based on an identified subset of additional edge nodes as neighbor nodes. Additionally or alternatively, a particular edge node can determine a subset of neighbor nodes by applying neighbor-decisioning techniques that evaluate whether an additional edge node in the decentralized edge computing network has model parameters that are sufficiently relevant to a model that is included in the particular edge node (e.g., fulfill a threshold criteria for determining relevance). In some cases, application of the neighbor-decisioning techniques can improve performance of one or more of the edge nodes included in the decentralized edge computing network, such as by increasing accuracy of the model in the particular edge node by incorporating partial information about model parameters from the subset of additional edge nodes in the decentralized edge computing network. Additionally or alternatively, application of the neighbor-decisioning techniques can reduce inefficient use of time and computing resources related to evaluation of additional edge nodes, by providing tools for the particular edge node to rapidly determine a relatively small subset of edge nodes with model parameters that are sufficiently relevant to the model of the particular edge node.

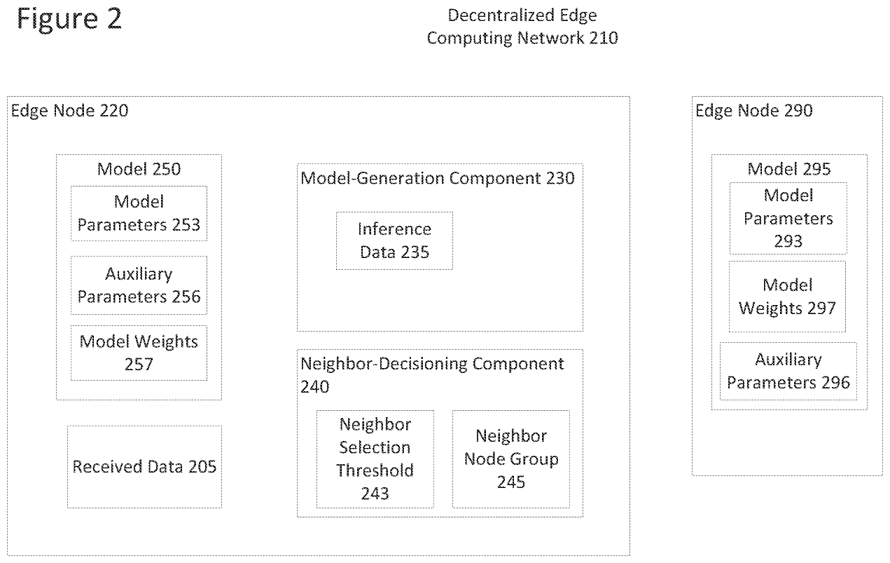

FIG. 2 depicts an example of a decentralized edge computing network 210 that includes one or more edge nodes configured to perform federated partial-data aggregation data modeling. For example, the dec edge 210 includes an edge node 220 and an edge node 290 that are configured to generate, train, or otherwise modify respective federated partial-data aggregation machine learning models. The decentralized edge computing network 210 is configured as an edge computing network, in which each of the included edge nodes, such as the edge nodes 220 and 290, performs one or more computing functions associated with a respective portion of one or more computing environments associated with the decentralized edge computing network 210. Additionally or alternatively, the decentralized edge computing network 210 is configured as a decentralized computing network, in which none of the included edge nodes, such as the edge nodes 220 and 290, is configured to perform functions that control operations of additional ones of the included edge nodes. Furthermore, the decentralized edge computing network 210 can arrange the included edge nodes, such as the edge nodes 220 and 290, in a network configuration that enables communication between any pair of edge nodes in the decentralized edge computing network 210.

In the decentralized edge computing network 210, each of the edge nodes 220 and 290 generates, trains, or otherwise modifies a respective machine learning model based on federated partial-data aggregation techniques. For example, the edge node 220 generates a model 250 that is a federated partial-data aggregation model. The model 250 is configured to generate one or more inferences for data received by the edge node 220, such as inferences that are based on received data 205. The model 250 includes one or more model parameters 253, such as model parameters that are generated or modified via machine learning techniques performed by the edge node 220. In some cases, the edge node 220 generates or modifies one or more of the model parameters 253 during training (e.g., online training) of the model 250, such as parameter modification that are determined based on comparison of inference data generated via the model 250 and groundtruth data received by the edge model 220 (e.g., during a subsequent period of time). Additionally or alternatively, the model 250 includes one or more auxiliary parameters 256, such as copies of model parameters that are received by the edge node 220 from one or more additional edge nodes in the decentralized edge computing network 210. In some cases, the edge node 220 modifies the auxiliary parameters 256 to include a particular copy of a model parameter received from a particular edge node, such as a neighbor node for the edge node 220. For example, responsive to identifying that the edge node 290 is a neighbor node, the edge node 220 can send to the edge node 290 a request to receive copies of one or more model parameters used by the edge node 290 (e.g., model parameters 293). The edge node 220 can modify the auxiliary parameters 256 to include the copies received from the edge node 290. In some cases, the model 250 includes one or more model weights 257, such as model weights that indicate an estimated relevance of one or more of the auxiliary parameters 256, with respect to the model 250. In some cases, the edge node 220 determines one or more values for the model weights 257 via machine learning techniques performed by the edge node 220.

Additionally or alternatively, the edge node 290 generates a model 295 that is a federated partial-data aggregation model. The model 295 is configured to generate one or more inferences for data received by the edge node 290. The model 295 includes one or more model parameters 293, such as model parameters that are generated or modified via machine learning techniques performed by the edge node 290. In some cases, the model 295 includes one or more model weights 297 that indicate an estimated relevance, with respect to the model 295, of one or more parameters from one or more additional models from additional edge nodes in the decentralized edge computing network 210. For example, the edge node 290 could determine that the edge node 220 is a neighbor node for the edge node 290. Responsive to identifying that the edge node 220 is a neighbor node, the edge node 290 can request copies of one or more of the model parameters 253. Additionally or alternatively, the model 295 includes a set of auxiliary parameters 296, such as copies of model parameters that are received by the edge node 290 from one or more additional edge nodes in the decentralized edge computing network 210. In some cases, the edge node 290 could modify the auxiliary parameters 296 to include the copies of model parameters received from the edge node 220. In FIG. 2, the edge nodes 220 and 290 are described as having reciprocal neighbor identifications, e.g., each identifying the other edge node as being a neighbor node. However, other implementations are possible, such as a decentralized edge computing network in which one or more edge nodes have non-reciprocal neighbor identifications.

In some embodiments, the model 250, the model parameters 253, the auxiliary parameters 256, the model weights 257, and the received data 205 are identified (e.g., by the edge node 220, by the decentralized edge computing network 210) as being local to the edge node 220. In some embodiments, the model 295, the model parameters 293, the model weights 297, the auxiliary parameters 296, and data received by the edge node 290 are identified (e.g., by the edge node 290, by the decentralized edge computing network 210) as being local to the edge node 290. In FIG. 2, the decentralized edge computing network 210 is configured to prevent one or more of the included edge nodes from accessing non-local data, e.g., preventing access to data received or generated by an additional included edge node. For example, the decentralized edge computing network 210 prevents the edge node 290 from accessing the received data 205 and also prevents the edge node 220 from accessing the data received by the edge node 290. Additionally or alternatively, the decentralized edge computing network 210 prevents the edge node 290 from accessing the model parameters 253, the auxiliary parameters 256, and the model weights 257 and also prevents the edge node 220 from accessing the model parameters 293, the auxiliary parameters 296, and the model weights 297. In some cases, a decentralized edge computing network that is configured to prevent access to non-local data can improve data security, such as by eliminating or reducing opportunities by malicious actors to compromise data during transmission. Additionally or alternatively, a decentralized edge computing network that is configured to prevent access to non-local data can improve network efficiency, such as by reducing network traffic related to data transmission. For example, transmission of a relatively small quantity of model parameters in a decentralized edge computing network can reduce network traffic while improving model quality within the decentralized edge computing network, as compared to transmission of a relatively large quantity of raw data points for training a model in a contemporary edge computing network.

In the decentralized edge computing network 210, an included edge node can include one or more of a model-generation component or a neighbor-decisioning component. For example, the edge node 220 includes a model-generation component 230 and a neighbor-decisioning component 240. Additionally or alternatively, the edge node 290 includes one or more of an additional model-generation component or an additional neighbor-decisioning component. In some cases, the additional model-generation component and the additional neighbor-decisioning component are configured somewhat similarly to the model-generation component 230 and the neighbor-decisioning component 240. For example, the additional model-generation component is configured to perform, with respect to the edge node 290, computer-implemented functions that are somewhat similar to computer-implemented functions performed by the model-generation component 230 with respect to the edge node 220. Additionally or alternatively, the additional neighbor-decisioning component is configured to perform, with respect to the edge node 290, computer-implemented functions that are somewhat similar to computer-implemented functions performed by the neighbor-decisioning component 240 with respect to the edge node 220.

In some embodiments, the neighbor-decisioning component 240 performs one or more computer-implemented functions related to determining a group of one or more neighbor edge nodes for the edge node 220, such as a neighbor node group 245. For example, the neighbor-decisioning component 240 can generate or modify the neighbor node group 245 to describe one or more edge nodes included in the decentralized edge computing network 210, such as the edge node 290. Additionally or alternatively, the neighbor-decisioning component 240 can generate or modify the neighbor node group 245 based on a determined relevance of a particular edge node to the model 250. For example, the neighbor-decisioning component 240 receives, from the model-generation component 230, one or more of the model weights 257. Additionally or alternatively, the neighbor-decisioning component 240 compares each of the received model weights 257 to a neighbor selection threshold 243 or otherwise evaluates the received model weights 257. Based on the evaluation, the neighbor-decisioning component 240 identifies one or more edge nodes that include models with relatively high estimated relevance to the model 250 of the edge node 220. Additionally or alternatively, the neighbor-decisioning component 240 identifies one or more edge nodes that include models with relatively low estimated relevance to the model 250 of the edge node 220. In FIG. 2, the neighbor-decisioning component 240 modifies the neighbor node group 245 to identify, as neighbor nodes for the edge node 220, a group of one or more edge nodes having models with relatively high estimated relevance to the model 250. For example, the neighbor-decisioning component 240 determines that a particular weight of the model weights 257 is associated with the edge node 290. Furthermore, the neighbor-decisioning component 240 determines that the particular weight meets or exceeds, or otherwise fulfills, the neighbor selection threshold 243. Responsive to determining that the particular weight meets or exceeds the neighbor selection threshold 243, the neighbor-decisioning component 240 modifies the neighbor node group 245 to identify the edge node 290 as a neighbor node for the edge node 220. Additionally or alternatively, the neighbor-decisioning component 240 determines that an additional weight associated with an additional edge node is below, or otherwise fails to fulfill, the neighbor selection threshold 243. Responsive to determining that the additional weight is below the neighbor selection threshold 243, the neighbor-decisioning component 240 modifies the neighbor node group 245 to exclude the additional edge node, e.g., identifying the additional edge node as a non-neighbor node for the edge node 220. In some cases, the neighbor node group 245 improves operations performed by edge node 220, as compared to a contemporary edge node that does not determine a neighbor node group. For example, the edge node 220 could generate or modify the model 250 with improved accuracy by identifying one or more neighbor nodes with relatively high estimated relevance to the model 250. In addition, the edge node 220 could reduce network traffic related to model updates, such as by eliminating or reducing network requests for model information from additional edge nodes that are not identified as neighbor nodes.

In some cases, the neighbor-decisioning component 240 evaluates the neighbor node group 245, such as evaluation of one or more neighbor nodes identified in the neighbor node group 245. In some cases, the neighbor-decisioning component 240 evaluates the neighbor node group 245 responsive to identifying at least one low-relevance neighbor node in the neighbor node group 245, such as a neighbor node that has a weight indicating a relatively low estimated relevance to the model 250. Additionally or alternatively, the neighbor-decisioning component 240 evaluates the neighbor node group 245 responsive to one or more additional criteria, such as a determination that the model-generation component 230 has performed a particular quantity of modifications (e.g., training updates) to the model 250, expiration of a time period (e.g., daily, weekly), or receiving data that describes a topology change of the decentralized edge computing network 210 (e.g., edge nodes are added or removed). In FIG. 2, evaluation of the neighbor node group 245 can include determining a set of one or more candidate neighbor nodes among the edge nodes in the decentralized edge computing network 210. Additionally or alternatively, evaluation of the neighbor node group 245 can involve including or excluding a candidate neighbor node based on an evaluation of a weight associated with the candidate neighbor node. In some embodiments, evaluation of the neighbor node group 245 includes receiving, by the neighbor-decisioning component 240, respective weights for one, some, or all of the edge nodes included in the decentralized edge computing network 210. The neighbor-decisioning component 240 can receive the respective weights from, for example, the model-generation component 230 or an additional component of the edge node 220. Additionally or alternatively, the neighbor-decisioning component 240 receives respective weights for a particular subset of the edge nodes included in the decentralized edge computing network 210, such as a candidate subset that includes one or more candidate neighbor nodes. For example, the candidate subset could include one or more candidate neighbor nodes that are identified as neighbor nodes in the neighbor node group 245, e.g., neighbor nodes of the edge node 220. Additionally or alternatively, the candidate subset could include additional candidate neighbor nodes that are identified as additional neighbor nodes associated with the neighbor nodes in the neighbor node group 245, e.g., additional neighbor nodes of the neighbor nodes of the edge node 220. For convenience and not by way of limitation, a neighbor node of a neighbor node for a particular edge node is referred to herein as a secondary neighbor or a two-hop neighbor of the particular edge node. Additional techniques for determining a candidate subset can include identifying a candidate neighbor node fulfilling one or more criteria, such an association with a geographical region of the decentralized edge computing network 210, an association with a particular portion of the decentralized edge computing network 210 (e.g., provides service to computing devices for a particular group of customers), or other suitable criteria for determining a candidate subset.

In some embodiments, the model-generation component 230 performs one or more computer-implemented functions related to generating, training, or otherwise modifying the model 250, such as generally described in regard to FIG. 1. Additionally or alternatively, the model-generation component 230 performs one or more computer-implemented functions related to generating or modifying inference data, such as inference data 235. For example, the model-generation component 230 generates the inference data 235 by applying the model 250 to the received data 205. The received data 205 can be associated with one or more computing devices that are included in the respective computing environment associated with the edge node 220. In some cases, the inference data 235 estimates a predicted outcome of the received data 205, such as a prediction about future activity by one or more of the computing devices. In some cases, the edge node 220 performs one or more additional operations based on the inference data 235, such as providing the inference data 235 or additional data (e.g., predictive content data) to one or more additional computing systems.

Additionally or alternatively, the model-generation component 230 modifies one or more of the model parameters 253 in the model 250 by applying machine learning techniques, such as online training, to the inference data 235. For example, the model-generation component 230 determines that the inference data 235 corresponds to a particular subset of the received data 205 at a particular timestep, such as a particular data subset received at timestep. Responsive to receiving an additional subset of the received data 205 at an additional timestep, such as an additional data subset received at subsequent timestep t+1, the model-generation component 230 determines groundtruth data for the inference data 235. In some cases, determining the groundtruth data for the inference data 235 includes comparing the inference data 235 to the additional data subset of the received data 205. Additionally or alternatively, the model-generation component 230 modifies one or more of the model parameters 253 based on the determined groundtruth. In some cases, the model-generation component 230 stabilizes one or more of the auxiliary parameters 256 or the model weights 257 during modification of the model parameters 253, such as by preventing additional modifications to the auxiliary parameters 256 or the model weights 257 while performing operations related to modifying the model parameters 253.

In the decentralized edge computing network 210, the model-generation component 230 modifies one or more of the auxiliary parameters 256 in the model 250 by applying federated partial-data aggregation machine learning techniques to the model 250. For example, the model-generation component 230 determines that the neighbor node group 245 identifies the edge node 290 as a neighbor node for the edge node 220. Additionally or alternatively, the model-generation component 230 (or another component of the edge node 220) sends to the edge node 290 request data, such as data describing a request to receive copies of one or more of the model parameters 293. In some cases, the model-generation component 230 requests copies of a most recent model parameter, such as a copy of the model parameters 293 at a current timestep. Additionally or alternatively, the model-generation component 230 requests copies of model parameters that fulfill one or more particular request criteria, such as a copy of the model parameters 293 (or a historical version of the parameters 293) that fulfill the particular request criteria. Examples of request criteria for a model parameter copy include a parameter that is associated with a particular timestep (e.g., timestep t, timestep t−3), a parameter that is within a threshold variation (e.g., is within a threshold amount of variation for a threshold quantity of timesteps), or other criteria for requesting copies of one or more model parameters. Responsive to receiving the copies of the model parameters 293, the model-generation component 230 modifies the auxiliary parameters 256, such as by identifying one or more parameter values in the received copies that are updated (e.g., as compared to the auxiliary parameters 256) and modifying the auxiliary parameters 256 to include the updated values. In some cases, the model-generation component 230 stabilizes one or more of the model parameters 253 or the model weights 257 during modification of the auxiliary parameters 256, such as by preventing additional modifications to the model parameters 253 or the model weights 257 while performing operations related to modifying the auxiliary parameters 256. Additionally or alternatively, the model-generation component 230 applies the model 250 based on the modified auxiliary parameters 256, such as utilizing the updated values while performing operations (e.g., subsequent to modifying the auxiliary parameters 256) related to generating additional inference data or performing additional training of the model 250.

In the decentralized edge computing network 210, the model-generation component 230 modifies one or more of the model weights 257 in the model 250 by applying federated partial-data aggregation machine learning techniques to the model 250. For example, the model-generation component 230 determines that one or more of the auxiliary parameters 256 has an updated value, such as an updated value that is based on a model parameter copy received from the edge node 290. Additionally or alternatively, the model-generation component 230 determines that the auxiliary parameters 256 are updated at a particular timestep, such as at timestep t+1. Responsive to determining that the auxiliary parameters 256 have an updated value at the timestep t+1, the model-generation component 230 identifies a particular inference (e.g., from the inference data 235) that is generated based on the updated value, such as at the timestep t+1. Additionally or alternatively, the model-generation component 230 determines additional groundtruth data for the particular inference, such as additional groundtruth data that is based on a comparison of the particular inference at the timestep t+1 with an additional data subset received at a subsequent timestep, e.g., at timestep t+2. Additionally or alternatively, the model-generation component 230 modifies one or more of the model weights 257 based on the determined additional groundtruth. In some cases, the model-generation component 230 stabilizes one or more of the auxiliary parameters 256 or the model parameters 253 during modification of the model weights 257, such as by preventing additional modifications to the auxiliary parameters 256 or the model weights 257 parameters 253 while performing operations related to modifying the model weights 257. Additionally or alternatively, the model-generation component 230 applies the model 250 based on the modified model weights 257, such as while performing operations (e.g., subsequent to modifying the model weights 257) related to generating additional inference data or performing additional training of the model 250.

In various embodiments, components of the decentralized edge computing network 210, such as the edge nodes 220 and 290, the models 250 and 295, the model-generation component 230, the neighbor-decisioning component 240, or other components, can be implemented as one or more of program code, program code executed by processing hardware (e.g., a processor, a programmable logic array, a field-programmable gate array, etc.), firmware, or some combination thereof.

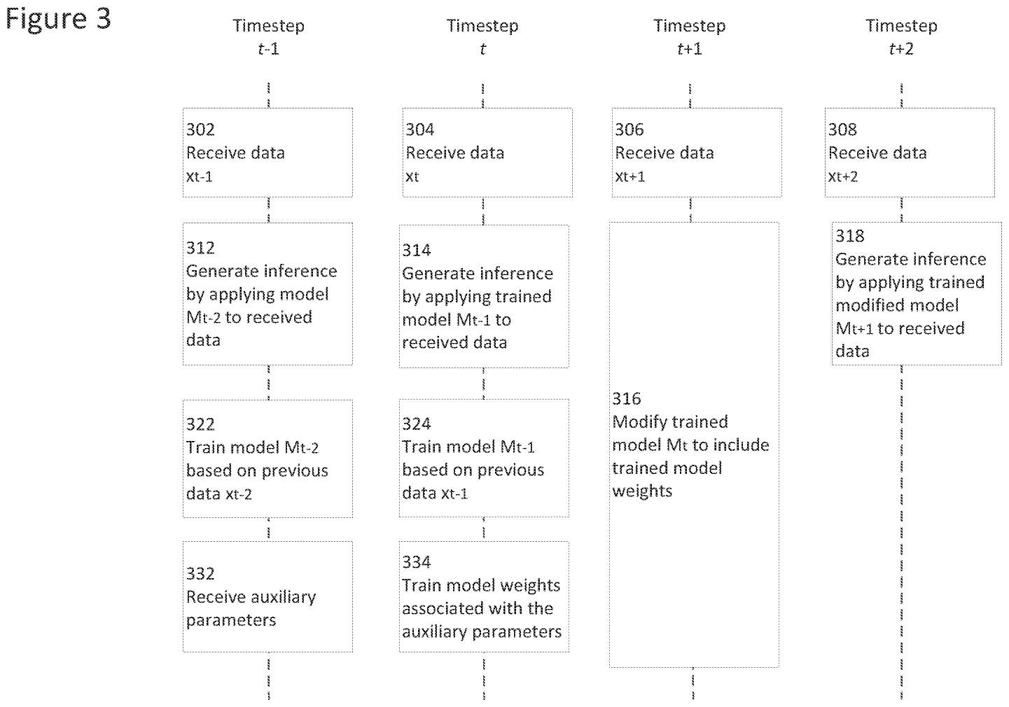

FIG. 3 depicts a diagram of an example data flow for one or more operations involved in federated partial-data aggregation machine learning techniques. In some cases, one or more of the operations described in FIG. 3 are performed by an edge node that is included in a decentralized edge computing network, such as one or more edge nodes included in the decentralized edge computing networks 110 or 210. For example, the edge node 220 can implement one or more of the operations described in FIG. 3.

In FIG. 3, at one or more of block 302, block 304, block 306, or block 308, an example edge node in an example decentralized edge computing network receives data at one or more timesteps. The received data can be local to the example edge node, such as local data that is accessible by the example edge node an inaccessible by additional edge nodes in the example decentralized edge computing network. For example, at block 302, the edge node 220 receives data xₜ₋₁ at timestep t−1. Additionally or alternatively, the edge node 220 receives data xₜ at timestep t at block 304, receives data xₜ₊₁ at timestep t+1 at block 306, and receives data xₜ₊₂ at timestep t+2 at block 308. In FIG. 2, each of the data xₜ₋₁ through xₜ₊₂ is local data that is received from one or more computing systems included in a portion of the decentralized edge computing network 210 that is associated with the edge node 220. Additionally or alternatively, the decentralized edge computing network 210 prevents additional edge nodes, such as the edge node 290, from accessing the data xₜ₋₁ through xₜ₊₂.

In FIG. 3, at one or more of block 312 or block 314, the example edge node generates inference data based on the received data. In some cases, the generated inference data is associated with the one or more timesteps. Additionally or alternatively, the generated inference data estimates predicted outcomes of applying a model to the received data. For example, at block 312, the edge node 220 generates inference data ŷₜ₋₁ by applying a model Mₜ₋₂ to the received data xₜ₋₁. In some cases, the model Mₜ₋₂ is a most recent available model at the timestep t−1. Additionally or alternatively, at block 314, the edge node 220 generates inference data ŷₜ by applying a model Mₜ₋₁ to the received data xₜ. In some cases, the model Mₜ₋₁ is a most recent available model at the timestep t. In some cases, the edge node 220 generates or modifies the inference data 235 to include one or more of the inference data ŷₜ₋₁ or ŷₜ. In some cases, the model-generation component 230 in the edge node 220 performs one or more operations related to blocks 312 and 314.

In FIG. 3, at one or more of block 322 or block 324, the example edge node trains the model, such as by comparing generated inferences to additional received data, e.g. groundtruth data. Additionally or alternatively, the example edge node trains the model by modifying one or more model parameters, such as model parameters that are determined by the example edge node. In some cases, the example edge node performs online training of the model, such as by training the model at all or nearly all timesteps. For example, at block 322, the edge node 220 trains the model Mₜ₋₂, such as by modifying one or more of the model parameters 253 that are associated with the model Mₜ₋₂. In some cases, the edge node 220 trains the model Mₜ₋₂ by comparing groundtruth data yₜ₋₂ with inference data ŷₜ₋₂ generated by an earlier model Mₜ₋₃ based on received data xₜ₋₂ at a previous timestep t−2. In some cases, the edge node 220 modifies one or more of the model parameters 253 based on the training, such as updating the model Mₜ₋₂ to the trained model Mₜ₋₁. Additionally or alternatively, at block 324, the edge node 220 trains the model Mₜ₋₁, such as by modifying one or more of the model parameters 253 that are associated with the model Mₜ₋₁. In some cases, the edge node 220 trains the model Mₜ₋₁ by comparing groundtruth data yₜ₋₁ with inference data ŷₜ₋₁ generated by the earlier model Mₜ₋₂ based on the received data xₜ₋₁ at the previous timestep t−1. In some cases, the edge node 220 generates inference data based on trained models, such as (e.g., at block 314) generating the inference data ŷₜ by applying the most recent available trained model Mₜ₋₁ at the timestep t. In some cases, the edge node 220 generates or modifies the model 250 to include one or more of the models (or trained models) Mₜ₋₃, Mₜ₋₂, or Mₜ₋₁. Additionally or alternatively, the edge node 220 modifies the model 250 to include a most recent available model at a particular timestep, e.g., the model Mₜ₋₁ that is the most recent available model at the timestep t. In some cases, the model-generation component 230 in the edge node 220 performs one or more operations related to blocks 322 and 324.

In FIG. 3, at block 332, the example edge node includes in the model one or more auxiliary parameters that are received from additional edge nodes in the example decentralized edge computing network. Additionally or alternatively, the example edge node trains one or more model weights that indicate a relative importance, to the model, of the auxiliary parameters. In some cases, the example edge node stabilizes additional components of the model during training of the model weights, such as stabilizing one or more of model parameters or auxiliary parameters. For example, at block 332, the edge node 220 receives one or more of the auxiliary parameters 256 from one or more additional edge nodes in the decentralized edge computing network 210, such as receiving copies of the model parameters 293 that are determined by the edge node 290. In some cases, one or more of the auxiliary parameters 256 are associated with a particular timestep, such as a timestep indicated by the edge node 290. In some cases, one or more of the auxiliary parameters 256 are unassociated with a particular timestep.

In some embodiments, at block 332, the edge node 220 includes one or more of the received auxiliary parameters 256 in the model 250. For example, the edge node 220 can modify the model Mₜ₋₂ (e.g., the most recent available model at the timestep t−1) to include the received auxiliary parameters. Additionally or alternatively, the edge node 220 includes one or more of the model weights 257 in the model 250. For example, the edge node 220 can modify the model Mₜ₋₂ to include one or more model weights. In some cases, the model weights for the model Mₜ₋₂ are associated with one or more of the auxiliary parameters, e.g., received at block 332, or the model parameters, e.g., trained at block 322. For example, the model weights 257 can include a particular weight (or weights) associated with the model parameters 253, and an additional weight (or weights) associated with the auxiliary parameters 256. In some cases, the example edge node, such as the edge node 220, generates or modifies a model using Equation 1.

$${M}_{t , agg}^{i} = \frac{{α}_{t}^{i , i} {M}_{t}^{i} + {\sum }_{j ∈ {ε}_{t}^{i}} {α}_{t}^{i , j} {M}^{j}}{{α}_{t}^{i , i} + {\sum }_{j ∈ {ε}_{t}^{i}} {α}_{t}^{i , j}} \qquad Eq . 1$$

In Equation 1, M_{t,agg}ⁱ is a model that is generated, trained, or applied by an edge node eⁱ that is included in a decentralized edge computing network, such as the edge node 220. The model M_{t,agg}ⁱ is associated with a timestep t. In some cases, the model M_{t,agg}ⁱ is generated or modified based on federated partial-data aggregation machine learning techniques. For example, the model M_{t,agg}ⁱ includes one or more values for model parameters Me that are trained by the edge node eⁱ at timestep t, such as the model parameters 253. In the model M_{t,agg}ⁱ the model parameters Mₜⁱ are aggregated with a sum of auxiliary parameters M^{j} that are received from one or more additional edge nodes e^{j} that are included in the decentralized edge computing network, such as the auxiliary parameters 256 that are received from the edge node 290. In the model M_{t,agg}ⁱ the auxiliary parameters M^{j} are associated with each additional edge node e^{j} included in a set εₜⁱ that is associated with the edge node eⁱ at timestep t. In some cases, the set εₜ^{j} is a group of neighbor nodes that are identified for the edge node eⁱ, such as the neighbor node group 245 identified for the edge node 220. For example, the set εₜⁱ includes neighbor nodes that are identified (e.g., based on an evaluation by the neighbor-decisioning component 240) as having respective models with parameters M^{j} that have relatively high estimated relevance for the model M_{t,agg}ⁱ. In the model M_{t,agg}ⁱ the model parameters Mₜⁱ and the auxiliary parameters M^{j} are weighted, such as by the model weights 257. For example, the model parameters Mₜⁱ are weighted with the model weight αₜ^{i,i} that indicates a relevance, at timestep t, of the model parameters Mₜⁱ with respect to the model M_{t,agg}ⁱ. In addition, the auxiliary parameters M_{t,agg}ⁱ that are weighted with the model weight αₜ^{i,j} that indicates a relevance, at timestep t, of the auxiliary parameters M^{j} with respect to the model M_{t,agg}ⁱ. In Equation 1, the model M_{t,agg}ⁱ is normalized by dividing a sum of the weighted parameters αₜ^{i,j}Mₜⁱ and αₜ^{i,j}M^{j} with a sum of the model weights αₜ^{i,j} and αₜ^{i,j}. In some cases, the model-generation component 230 in the edge node 220 performs one or more operations related to block 332, such as modifying the auxiliary parameters M^{j}. In some cases, the neighbor-decisioning component 240 in the edge node 220 performs one or more operations related to block 332, such as identifying the neighbor node group 245 (e.g., the set εₜⁱ for the model M_{t,agg}ⁱ).

In FIG. 3, at block 334, the example edge node trains the model weights that are included in the model. Additionally or alternatively, the example edge node stabilizes one or more of the parameters included in the model during the model weight training, such as stabilizing the model parameters (e.g., determined by the example edge node at blocks 322 or 324) and also stabilizing the auxiliary parameters (e.g., received by the example edge node at block 332). As used herein, stabilizing a parameter (or other portion of a model) during training includes holding a value of the parameter stable (e.g., prohibiting variation, “freezing”) during the training. For example, at block 334, the edge node 220 trains the model weights 257 that are included in the model Mₜ₋₁, such as a model weight αₜ₋₁^{i,i} or a model weight αₜ₋₁^{i,j}. Additionally or alternatively, the edge node 220 stabilizes parameters in the model Mₜ₋₁ during training of the model weights. For example, the edge node 220 stabilizes the model parameters 253 and the auxiliary parameters 256 during training of the model weights 257. In some cases, the model-generation component 230 in the edge node 220 performs one or more operations related to block 334.

In some embodiments, the example edge node, such as the edge node 220, trains one or more model weights using Equation 2.

$${α}_{t}^{* i} = arg {min}_{{α}_{t}^{i}} L ( {M}_{t , agg}^{i} ( {X}_{t}^{i} ) , {y}_{t}^{i} ) \qquad Eq . 2$$

In Equation 2, αₜ*ⁱ is a vector of learned model weights that are learned at timestep t for the model M_{t,agg}ⁱ. The learned model weights αₜ*ⁱ are determined by an edge node eⁱ that is included in a decentralized edge computing network, such as the edge node 220. Additionally or alternatively, the learned model weights αₜ*ⁱ are determined based on a minimization function arg min L for each model weight in a vector of model weights αₜ*ⁱ that are included in the model M_{t,agg}ⁱ at timestep t, such as model weights αₜⁱ that were previously learned by the example edge node (e.g., during timestep t−1). In Equation 2, the minimization function arg min L is calculated using a set of received data Xₜⁱ that includes one or more data points xₜ that are received by the edge node eⁱ at timestep t. Additionally or alternatively, the minimization function arg min L is calculated using groundtruth data yₜⁱ that is determined by the edge node eⁱ for the received data Xₜⁱ (e.g., determined during a subsequent timestep t++1). In some cases, calculating the learned model weights αₜ*ⁱ is performed during a subsequent timestep. For example, at block 334, the edge node 220 calculates the learned model weights αₜ₋₁*ⁱ for the model Mₜ₋₁ during a subsequent timestep, such as timestep t. Additionally or alternatively, during determination of the learned model weights αₜ*ⁱ, the example edge node stabilizes one or more model parameters Mₜⁱ or auxiliary parameters M^{j} in the model M_{t,agg}ⁱ. For example, at block 334, the edge node 220 determines one or more learned model weights αₜ*ⁱ for the model Mₜ₋₁, while stabilizing more model parameters Mₜ₋₁ and auxiliary parameters M^{j} that are included in the model Mₜ₋₁.

In Equation 2, the vector of model weights αₜⁱ includes model weights that are associated with model parameters, such as a model weight αₜ^{i,i}, and auxiliary parameters, such as a model weight αₜ^{i,j}. In some cases, the vector of model weights αₜⁱ is determined by the example edge node, such as the edge node 220, using Equation 3.

$${α}_{t}^{i} = \{ {α}_{t}^{i , i} \} ⋃ \{ {α}_{t}^{i , j} \vert j ∈ {ε}_{t}^{i} \} \qquad Eq . 3$$

In Equation 3, the vector of model weights αₜⁱ is a union combination of the model weight αₜ^{i,i} and one or more model weights αₜ^{i,j}. The model weight αₜ^{i,i} is associated with model parameters of the model M_{t,agg}ⁱ, such as the model parameters Mₜⁱ described in regard to Equation 1. The one or more model weights αₜ^{i,j} are associated with auxiliary parameters of each neighbor node eⁱ that is included in the set εₜⁱ for the model M_{t,agg}ⁱ, such as the auxiliary parameters M^{j} described in regard to Equation 1. For example, the edge node 220 determines the vector of model weights αₜⁱ by identifying (e.g., from the model weights 257) a combination of model weights that are associated with the model parameters 253 and additional model weights that are associated with the auxiliary parameters 256.

In FIG. 3, at block 316, the example edge node modifies a model, such as a trained model, to include one or more trained model weights. In some cases, the example edge node modifies a trained model associated with a particular timestep, e.g., timestep t, to include trained model weights associated with an additional timestep, e.g., timestep t−1. For example, at block 316, the edge node 220 determines a trained model Mₜ that is utilized during the timestep t+1. In some cases, the trained model Mₜ is trained by the edge node 220 during the timestep t+1, such as based on received data xₜ and groundtruth data yₜ. In some cases, the trained model Mₜ is determined by the edge node 220 based on an additional model, such as the previously trained model Mₜ₋₁. Additionally or alternatively, the edge node 220 generates a trained modified model Mₜ₊₁ by modifying the trained model Mₜ to include one or more trained model weights, such as the learned model weights αₜ₋₁*ⁱ calculated by the edge node 220 at block 334. In some cases, the edge node 220 generates or modifies the model 250 to include the trained modified model Mₜ₊₁. In some cases, the model-generation component 230 in the edge node 220 performs one or more operations related to block 316.

In FIG. 3, at block 318, the example edge node generates inference data by applying the trained modified model. Additionally or alternatively, the generated inference data estimates predicted outcomes of applying the trained modified model to the received data. For example, at block 318, the edge node 220 generates inference data ŷₜ₊₂ by applying the trained modified model Mₜ₊₁ to the received data xₜ₊₂, e.g., during the timestep t+2. In some cases, the trained modified model Mₜ₊₁ is a most recent available model at the timestep t+2. Additionally or alternatively, the edge node 220 generates or modifies the inference data 235 to include the inference data ŷₜ₊₂. In some cases, the model-generation component 230 in the edge node 220 performs one or more operations related to block 318.

FIG. 3 depicts particular blocks that are arranged in a column as being associated with a particular timestep that is arranged in the column, such as blocks 302, 312, 322, and 332 as being associated with the timestep t−1. In FIG. 3, association of a particular block with a particular timestep may, but need not, indicate that one or more operations related to the particular block are performed during the particular timestep. For example, the edge node 220 may, but need not, perform one or more operations related to the blocks 302, 312, 322, and 332 during the timestep t−1.

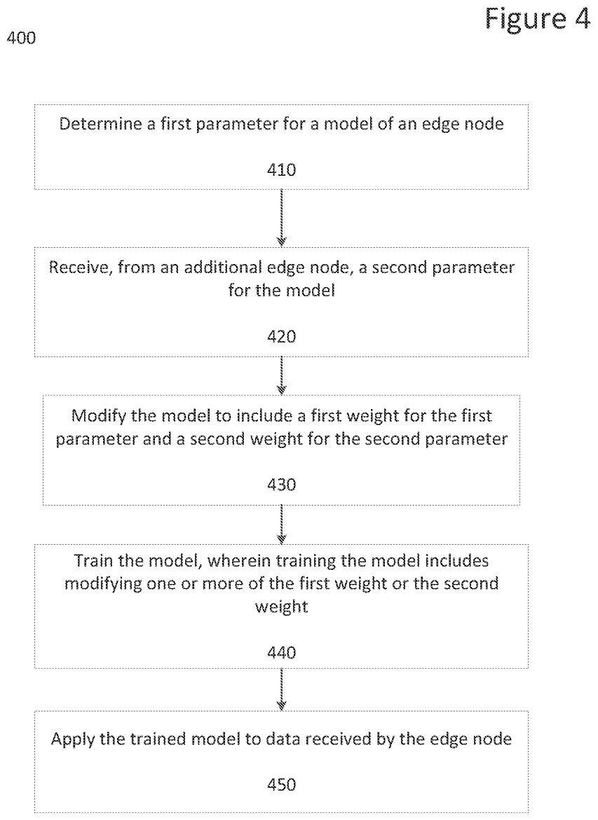

FIG. 4 is a flow chart depicting an example of a process 400 for training a model based on federated partial-data aggregation machine learning techniques. In some embodiments, such as described in regards to FIGS. 1-3, a computing device executing an edge node included in a decentralized edge computing network implements operations described in FIG. 4, by executing suitable program code. For illustrative purposes, the process 400 is described with reference to the examples depicted in FIGS. 1-3. Other implementations, however, are possible. In some embodiments, one or more operations described herein with respect to the process 400 can be used to implement one or more steps for performing federated partial-data aggregation machine learning techniques.

At block 410, the process 400 involves determining, such as by an edge node in a decentralized edge computing network, a first parameter for a model of the edge node. In some cases, the first parameter is a model parameter for the model. Additionally or alternatively, the first parameter is calculated by the edge node, such as via machine learning techniques. For example, the model-generation component 230 in the edge node 220 calculates one or more of the model parameters 253 for the model 250, such as by online training of the model 250 via machine learning techniques. In some embodiments, the edge node generates inference data by applying the model and the first parameter to received data. For example, the edge node 220 generates the inference data 235 by applying the model 250, including the model parameters 253, to the received data 205.

At block 420, the process 400 involves receiving, by the edge node, a second parameter for the model. In some cases, the edge node receives the second parameter from an additional edge node in the decentralized edge computing network. Additionally or alternatively, the second parameter is included in an additional model of the additional edge node. In some cases, the edge node identifies the additional edge node as a neighbor node based on a determination that one or more parameters of the additional model, such as the second parameter, have a relatively high estimated relevance to the model. Responsive to identifying the additional edge node as a neighbor node, the edge node requests the second parameter from the additional edge node. For example, the neighbor-decisioning component 240 in edge node 220 determines that the edge node 290 is a neighbor node identified in the neighbor node group 245. In some cases, the neighbor-decisioning component 240 identifies the edge node 290 as a neighbor node based on a determination that the model parameters 293 in the model 295 have a relatively high estimated relevance to the model 250. Additionally or alternatively, the edge node 220 modifies the auxiliary parameters 256 to include copies of the model parameters 293 that are received from the edge node 290.

At block 430, the process 400 involves modifying, by the edge node, the model to include one or more weights for respective parameters in the model. In some cases, the edge node modifies the model to include a first weight that is associated with the first parameter determined by the edge node. Additionally or alternatively, the edge node modifies the model to include a second weight that is associated with the second parameter received from the additional edge node. For example, the model-generation component 230 in the edge node 220 modifies the model 250 to include one or more of the model weights 257. In some cases, the model weights 257 include a particular weight (or weights) that is associated with the model parameters 253, and an additional weight (or weights) that is associated with the auxiliary parameters 256.

At block 440, the process 400 involves training, by the edge node, one or more portions of the model. Additionally or alternatively, the training can involve training a particular portion of the model while stabilizing an additional portion of the model. For example, the edge node trains the first weight and the second weight based on data received by the edge node. Additionally or alternatively, the edge node trains the first weight and the second weight while stabilizing one or more of the first parameter or the second parameter. In some cases, the edge node trains the weights to indicate a respective estimated relevance of the associated parameters to the model. For example, the edge node trains the first weight to indicate an estimated relevance of the first parameter for the model and the second weight to indicate an estimated relevance of the second parameter for the model. For example, the model-generation component 230 in the edge node 220 trains one or more of the model weights 257 in the model 250, while stabilizing the model parameters 253 and auxiliary parameters 256.

At block 450, the process 400 involves applying the trained model to data that is received by the edge node, such as additional data that is received subsequent to training the weights. In some cases, the edge node trains first weight and the second weight based on data that is available during a particular timestep, and applies the model with the trained first and second weights to additional data received in an additional timestep. For example, the model-generation component 230 trains the model weights 257 based on a portion of the received data 205 that is available during a particular timestep t, and applies the trained model 250 to an additional portion of the received data 205 that is available during a subsequent timestep t−1. In some cases, the edge node 220 generates the inference data 235 by applying the model 250, e.g., with the trained model weights 257, to the received data 205.

In some embodiments, one or more operations described herein with respect to blocks 420-440 can be used to implement one or more steps for federated partial-data aggregation machine learning techniques. FIG. 4 depicts the process 400 as proceeding from block 410 through block 450, but additional implementations are possible, such as performing one or more described operations simultaneously or in an alternative order.

In some embodiments, a decentralized edge computing network includes a relatively large quantity of edge nodes, such as several hundred or thousand edge nodes. In this example decentralized edge computing network with the relatively large quantity of edge nodes, it can be impractical for a particular edge node to request parameter information or to evaluate model weights for each additional edge node in the example decentralized edge computing network. In some cases, the particular edge node can improve accuracy and reduce network traffic by determining a neighbor node group of additional edge nodes that have relatively high relevance for the particular edge node, such as identifying neighbor nodes that include model parameters that have relatively high estimated relevance for a model of the particular edge node. In some cases, an example edge node, such as the edge node 220, generates or modifies a neighbor node group using Equation 4.

$${α}_{t}^{i , k} = {\sum }_{j ∈ {ε}_{t}^{i} if k ∈ {ε}_{t}^{j}} {α}_{t}^{i , j} {α}_{t}^{j , k} \qquad Eq . 4$$

In Equation 4, an edge node e′ that is included in a decentralized edge computing network, such as the edge node 220, determines a candidate weight at αₜ^{i,k} for a candidate neighbor node for the set εₜⁱ of neighbor nodes, such as the neighbor node group 245. For example, the neighbor-decisioning component 240 in the edge node 220 determines the set εₜⁱ of neighbor nodes that are identified by the neighbor node group 245. In some cases, the example edge node eⁱ determines the candidate weight αₜ^{i,k} responsive to an evaluation of the set εₜⁱ of neighbor nodes, such as an evaluation by the neighbor-decisioning component 240 of the neighbor node group 245. The set εₜⁱ for the edge node eⁱ includes one or more neighbor nodes e^{j} that are included in the decentralized edge computing network, such as the edge node 290. Additionally or alternatively, the example edge node eⁱ determines, for each neighbor node e^{j} in the set εₜⁱ, the model weight αₜ^{i,j} that indicates a relevance, at timestep t, of the auxiliary parameters M^{j} with respect to the model M_{t,agg}ⁱ. In some cases, the example edge node determines that at least one neighbor node in the set εₜⁱ has a model weight that indicates a relatively low estimated relevance to the model M_{t,agg}ⁱ, such as a particular neighbor node associated with a model weight that does not fulfill the neighbor selection threshold 243. Additionally or alternatively, the example edge node determines one or more additional model weights αₜ^{j,k} that are associated with secondary neighbors (e.g., two-hop neighbors) of the particular neighbor node. Each additional model weight αₜ^{j,k} indicates an estimated relevance of parameters of a secondary neighbor node e^{k} with respect to the neighbor node e^{j}. In some cases, the example edge node identifies one or more of the secondary neighbors as candidate neighbor nodes. For example, the edge node 220 requests, from the edge node 290, one or more additional model weights αₜ^{j,k} that indicate an estimated relevance, to the model 295 in edge node 290, of additional parameters for neighbor nodes of the edge node 290 (e.g., additional model weights indicating relevance of the auxiliary parameters 296 to the model 295). Additionally or alternatively, the neighbor-decisioning component 240 identifies the neighbor nodes of the edge node 290 as candidate neighbor nodes, such as candidate nodes that could be used to modify the neighbor node group 245 (e.g., add or remove neighbor nodes).

In Equation 4, the example edge node determines, for each secondary neighbor node e^{k} for each the neighbor node e^{j}, a product of the additional model weights αₜ^{j,k} and the model weight αₜ^{i,j}. Additionally or alternatively, the example edge node determines a candidate weight αₜ^{i,k} based on a sum of the products. In some cases, the example edge node modifies the set εₜⁱ of neighbor nodes based on the candidate weight αₜ^{i,k}, such as such as a modification that involves including a particular secondary neighbor node e^{k} (e.g., associated with the candidate weight αₜ^{i,k}) in the set εₜⁱ of neighbor nodes. For example, the neighbor-decisioning component 240 in the edge node 220 modifies the neighbor node group 245 to include a particular candidate neighbor node (e.g., secondary neighbor node e^{k}) responsive to determining that the associated candidate weight (e.g., candidate weight αₜ^{i,k}) fulfills the neighbor selection threshold 243. Additionally or alternatively, modification of the set εₜⁱ of neighbor nodes can involve removing a particular neighbor node e^{j}, such as a particular neighbor node having a model weight indicating a relatively low estimated relevance to the model M_{t,agg}ⁱ. For example, responsive to determining that the model weight associated with edge node 290 fails to fulfill the neighbor selection threshold 243, the neighbor-decisioning component 240 in the edge node 220 modifies the neighbor node group 245 to exclude the edge node 290. In some cases, a particular candidate neighbor node which had previously been excluded from the set εₜⁱ of neighbor nodes can be included during an additional evaluation of the set εₜⁱ of neighbor nodes, such as if a candidate weight of the particular candidate neighbor node has changed (e.g., the particular candidate node has a relevance that has changed with respect to the example edge node).

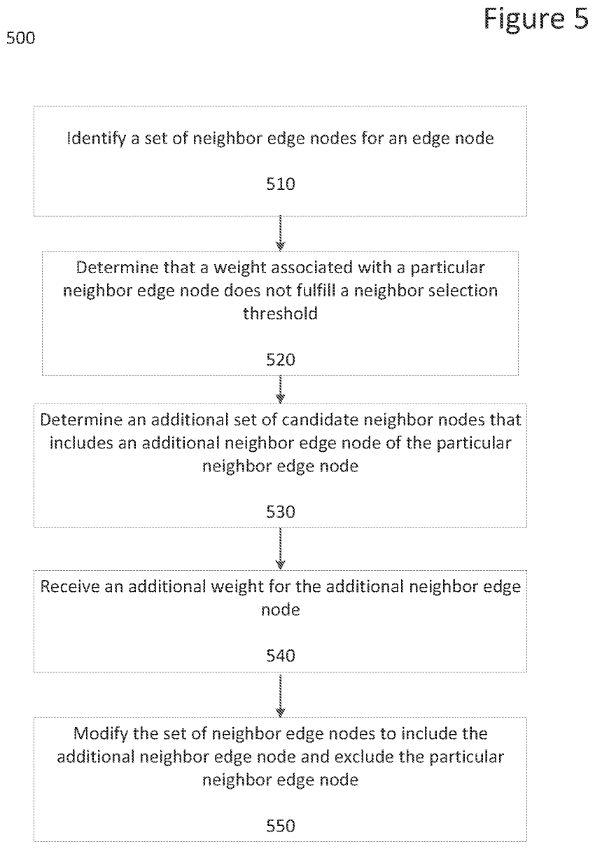

FIG. 5 is a flow chart depicting an example of a process 500 for determining a neighbor node group for an edge node that is included in a decentralized edge computing network. In some embodiments, such as described in regards to FIGS. 1-4, a computing device executing an edge node included in a decentralized edge computing network implements operations described in FIG. 5, by executing suitable program code. For illustrative purposes, the process 500 is described with reference to the examples depicted in FIGS. 1-4. Other implementations, however, are possible. In some embodiments, one or more operations described herein with respect to the process 500 can be used to implement one or more steps for determining a neighbor node group for an edge node included in a decentralized edge computing network.

At block 510, the process 500 involves identifying, such as by an edge node in a decentralized edge computing network, a set of one or more neighbor edge nodes, such as a neighbor node group for the edge node. In some cases, each of the neighbor edge nodes is an additional edge node in the decentralized edge computing network. For example, the neighbor-decisioning component 240 in the edge node 220 determines the neighbor node group 245 that includes the edge node 290 from the dec edge 210. In some cases, the edge node determines the set of one or more neighbor edge nodes based on respective model weights associated with the neighbor edge nodes. For example, the neighbor-decisioning component 240 determines the neighbor node group 245 based on the model weights 257.

At block 520, the process 500 involves determining, by the edge node, that a particular weight associated with a particular neighbor edge node does not fulfill a neighbor selection threshold. In some cases, the edge node evaluates the neighbor node group by comparing the neighbor selection threshold to one or more respective weights of the neighbor edge node, such as the particular weight. For example, the neighbor-decisioning component 240 compares a particular model weight in the neighbor node group 245 to the neighbor selection threshold 243, such as during an evaluation of the neighbor node group 245. Additionally or alternatively, the neighbor-decisioning component 240 determines that the particular model weight does not fulfill the neighbor selection threshold 243, such as a particular model weight associated with the edge node 290.

At block 530, the process 500 involves determining, by the edge node, an additional set of candidate neighbor nodes for the edge node, such as a candidate subset for the edge node. In some cases, each of the candidate neighbor edge nodes is an additional edge node in the decentralized edge computing network. Additionally or alternatively, one or more of the candidate neighbor nodes is identified as an additional neighbor edge node of the particular neighbor edge node, such as a secondary neighbor node with respect to the edge node. For example, the neighbor-decisioning component 240 identifies, from one or more additional edge nodes in the decentralized edge computing network 210, a candidate subset of candidate neighbor nodes for the edge node 220. Additionally or alternatively, responsive to determining that the particular model weight associated with the edge node 290 does not fulfill the neighbor selection threshold 243, the neighbor-decisioning component 240 includes in the candidate subset an additional neighbor node of the edge node 290, e.g., a secondary neighbor node with respect to the edge node 220.

At block 540, the process 500 involves receiving, by the edge node, a candidate weight that is associated with the additional neighbor edge node that is included in the set of candidate neighbor nodes. In some cases, the edge node calculates the candidate weight, such as described in regard to Equation 4. Additionally or alternatively, the edge node receives the candidate weight, or a value upon which the candidate weight is calculated, from the particular neighbor edge node. For example, the edge node 220 receives, from the edge node 290, a particular one of the model weights 297 that is associated with the additional neighbor node of the edge node 290. Additionally or alternatively, the neighbor-decisioning component 240 calculates a candidate weight that is associated with the additional neighbor node, such as a candidate weight based on the particular one of the model weights 297.

At block 550, the process 500 involves modifying, by the edge node, the set of one or more neighbor edge nodes for the edge node. In some cases, the modification involves including, in the set of one or more neighbor edge nodes, the additional neighbor edge node that is included in the set of candidate neighbor nodes. Additionally or alternatively, the modification involves excluding, from the set of one or more neighbor edge nodes, the particular neighbor edge node. In some cases, the edge node modifies the set of neighbor edge nodes based on respective comparisons of one or more weights with the neighbor selection threshold, such as responsive to determining that the candidate weight fulfills the neighbor selection threshold. For example, the neighbor-decisioning component 240 modifies the neighbor node group 245 to include the additional neighbor node of the edge node 290, responsive to determining that the candidate weight associated with the additional neighbor node fulfills the neighbor selection threshold 243. Additionally or alternatively, the neighbor-decisioning component 240 modifies the neighbor node group 245 to exclude the edge node 290, responsive to determining that the particular model weight associated with the edge node 290 does not fulfill the neighbor selection threshold 243.

In some embodiments, one or more operations described herein with respect to blocks 520-550 can be used to implement one or more steps for determining a neighbor node group for an edge node included in a decentralized edge computing network. FIG. 5 depicts the process 500 as proceeding from block 510 through block 550, but additional implementations are possible, such as performing one or more described operations simultaneously or in an alternative order.

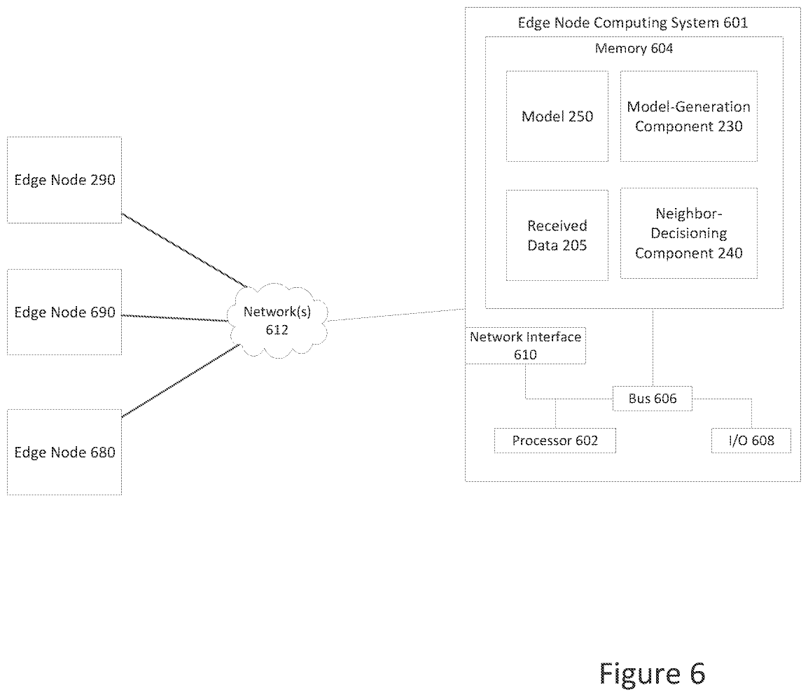

Any suitable computing system or group of computing systems can be used for performing the operations described herein. For example, FIG. 6 is a block diagram depicting an edge node computing system 601 that is configured to implement an edge node in a decentralized edge computing network, such as the edge node 220. In some embodiments, the edge node computing system 601 is configured to generate one or more federated partial-data aggregation machine learning models, as described elsewhere herein.

The depicted example of the edge node computing system 601 includes one or more processors 602 communicatively coupled to one or more memory devices 604. The processor 602 executes computer-executable program code or accesses information stored in the memory device 604. Examples of processor 602 include a microprocessor, an application-specific integrated circuit (“ASIC”), a field-programmable gate array (“FPGA”), or other suitable processing device. The processor 602 can include any number of processing devices, including one.

The memory device 604 includes any suitable non-transitory computer-readable medium for storing the model 250, the model-generation component 230, the neighbor-decisioning component 240, the received data 205, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The edge node computing system 601 may also include a number of external or internal devices such as input or output devices. For example, the edge node computing system 601 is shown with an input/output (“I/O”) interface 608 that can receive input from input devices or provide output to output devices. A bus 606 can also be included in the edge node computing system 601. The bus 606 can communicatively couple one or more components of the edge node computing system 601.

The edge node computing system 601 executes program code that configures the processor 602 to perform one or more of the operations described above with respect to FIGS. 1-5. The program code includes operations related to, for example, one or more of the model 250, the model-generation component 230, the neighbor-decisioning component 240, the received data 205, or other suitable applications or memory structures that perform one or more operations described herein. The program code may be resident in the memory device 604 or any suitable computer-readable medium and may be executed by the processor 602 or any other suitable processor. In some embodiments, the program code described above, the model 250, the model-generation component 230, the neighbor-decisioning component 240, and the received data 205 are stored in the memory device 604, as depicted in FIG. 6. In additional or alternative embodiments, one or more of the model 250, the model-generation component 230, the neighbor-decisioning component 240, the received data 205, and the program code described above are stored in one or more additional memory devices accessible by the edge node computing system 601.

The edge node computing system 601 depicted in FIG. 6 also includes at least one network interface 610. The network interface 610 includes any device or group of devices suitable for establishing a wired or wireless data connection to one or more data networks 612. Non-limiting examples of the network interface 610 include an Ethernet network adapter, a modem, and/or the like. One or more additional edge nodes in a decentralized edge computing network are connected to the edge node computing system 601 via network 612, such as the edge node 290, an additional edge node 690, or an additional edge node 680. The edge node computing system 601 is able to communicate with one or more of the edge node 290, the additional edge node 690, or the additional edge node 680 using the network interface 610.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A system for generating a federated partial-data aggregation model used by an edge node in a decentralized edge computing network, the system comprising:
a first edge node in the decentralized edge computing network, the first edge node configured to communicate with a second edge node in the decentralized edge computing network,
the first edge node comprising:
a model-generation component configured for:
determining a first parameter for a first model of the first edge node;
receiving, from the second edge node, a second parameter for the first model, wherein the second parameter is included in a second model of the second edge node;
modifying the first model to include a first weight for the first parameter and a second weight for the second parameter; and
training the first model based on data received by the first edge node, wherein training the first model includes modifying one or more of the first weight or the second weight,
wherein the first edge node applies the trained first model to additional data received by the first edge node.

2. The system of claim 1, the first edge node further comprising a neighbor-decisioning component configured for:
identifying a set of neighbor edge nodes for the first edge node, wherein the set of neighbor edge nodes includes the second edge node;
determining, for a particular neighbor edge node in the set of neighbor edge nodes, that a particular weight associated with the particular neighbor edge node is below a neighbor selection threshold;
determining an additional set of candidate neighbor nodes for the first edge node, wherein at least one of the candidate neighbor nodes in the additional set of candidate neighbor nodes is an additional neighbor node of the particular neighbor edge node;
receiving a candidate weight associated with the additional neighbor node; and
responsive to determining that the candidate weight is above the neighbor selection threshold, modifying the set of neighbor edge nodes to a) exclude the particular neighbor edge node from the set of neighbor edge nodes and b) include the additional neighbor node in the set of neighbor edge nodes.

3. The system of claim 2, wherein the neighbor-decisioning component is configured for identifying the additional set of candidate neighbor nodes responsive to determining that the particular weight associated with the particular neighbor edge node is below the neighbor selection threshold.

4. The system of claim 2, wherein the neighbor-decisioning component is configured for identifying the additional set of candidate neighbor nodes responsive to determining that the model-generation component has performed a particular quantity of modifications to the first model.

5. The system of claim 1, wherein the data on which the first model is trained is received by the first edge node at a timestep prior to receiving the second parameter from the second edge node.

6. The system of claim 1, wherein the model-generation component is further configured for modifying the first model based on an aggregation of the first parameter and the second parameter.

7. The system of claim 1, wherein the model-generation component is further configured for stabilizing the first parameter and the second parameter during the modifying of the one or more of the first weight or the second weight.

8. A method of training a federated partial-data aggregation model used by an edge node in a decentralized edge computing network, the method comprising:
determining, by a model-generation component included in a first edge node in the decentralized edge computing network, a first parameter for a first model of the first edge node;
receiving, by the model-generation component and from a second edge node in the decentralized edge computing network, a second parameter for the first model, wherein the second parameter is included in a second model of the second edge node;
modifying, by the model-generation component, the first model to include a first weight for the first parameter and a second weight for the second parameter;
training, by the model-generation component, the first model based on data received by the first edge node, wherein training the first model includes modifying one or more of the first weight or the second weight; and
applying, by the model-generation component, the trained first model to additional data received by the first edge node.

9. The method of claim 8, the method further comprising:
identifying, by a neighbor-decisioning component included in the first edge node, a set of neighbor edge nodes for the first edge node, wherein the set of neighbor edge nodes includes the second edge node;
determining, by the neighbor-decisioning component and for a particular neighbor edge node in the set of neighbor edge nodes, that a particular weight associated with the particular neighbor edge node is below a neighbor selection threshold;
determining, by the neighbor-decisioning component, an additional set of candidate neighbor nodes for the first edge node, wherein at least one of the candidate neighbor nodes in the additional set of candidate neighbor nodes is an additional neighbor node of the particular neighbor edge node;
receiving, by the neighbor-decisioning component, a candidate weight associated with the additional neighbor node; and
responsive to determining that the candidate weight is above the neighbor selection threshold, modifying, by the neighbor-decisioning component, the set of neighbor edge nodes to a) exclude the particular neighbor edge node from the set of neighbor edge nodes and b) include the additional neighbor node in the set of neighbor edge nodes.

10. The method of claim 9, the method further comprising:
determining, by the neighbor-decisioning component, that the particular weight associated with the particular neighbor edge node is below the neighbor selection threshold,
wherein identifying the additional set of candidate neighbor nodes is responsive to determining that the particular weight associated with the particular neighbor edge node is below the neighbor selection threshold.

11. The method of claim 9, the method further comprising:
determining, by the neighbor-decisioning component, that the model-generation component has performed a particular quantity of modifications to the first model,
wherein identifying the additional set of candidate neighbor nodes is responsive to determining that the model-generation component has performed the particular quantity of modifications to the first model.

12. The method of claim 8, the method further comprising modifying, by the model-generation component, the first model based on an aggregation of the first parameter and the second parameter.

13. The method of claim 8, the method further comprising stabilizing, by the model-generation component, the first parameter and the second parameter during the modifying of the one or more of the first weight or the second weight.

14. A non-transitory computer-readable medium embodying program code for generating a federated partial-data aggregation model used by an edge node in a decentralized edge computing network, the program code comprising instructions which, when executed by a processor, cause the processor to perform operations comprising:
determining a first parameter for a first model of a first edge node in the decentralized edge computing network;
receiving, from a second edge node in the decentralized edge computing network, a second parameter for the first model, wherein the second parameter is included in a second model of the second edge node;
a step for training the first model to include a modified first weight for the first parameter and a modified second weight for the second parameter; and
applying the trained first model to data received by the first edge node.

15. The non-transitory computer-readable medium of claim 14, the operations further comprising:
identifying a set of neighbor edge nodes for the first edge node, wherein the set of neighbor edge nodes includes the second edge node;
determining, for a particular neighbor edge node in the set of neighbor edge nodes, that a particular weight associated with the particular neighbor edge node is below a neighbor selection threshold;
determining an additional set of candidate neighbor nodes for the first edge node, wherein at least one of the candidate neighbor nodes in the additional set of candidate neighbor nodes is an additional neighbor node of the particular neighbor edge node;
receiving a candidate weight associated with the additional neighbor node; and
responsive to determining that the candidate weight is above the neighbor selection threshold, modifying the set of neighbor edge nodes to a) exclude the particular neighbor edge node from the set of neighbor edge nodes and b) include the additional neighbor node in the set of neighbor edge nodes.

16. The non-transitory computer-readable medium of claim 15, the operations further comprising identifying the additional set of candidate neighbor nodes responsive to determining that the particular weight associated with the particular neighbor edge node is below the neighbor selection threshold.

17. The non-transitory computer-readable medium of claim 15, the operations further comprising identifying the additional set of candidate neighbor nodes responsive to determining performance of a particular quantity of modifications to the first model.

18. The non-transitory computer-readable medium of claim 14, wherein training the first model is based on additional data received by the first edge node at a timestep prior to receiving the second parameter from the second edge node.

19. The non-transitory computer-readable medium of claim 14, the operations further comprising modifying the first model based on an aggregation of the first parameter and the second parameter.

20. The non-transitory computer-readable medium of claim 14, the operations further comprising stabilizing the first parameter and the second parameter during the training the first model to include the modified first weight and the modified second weight.
